(19) United States
(12) Patent Application Publication
(10) Pub. No.: US 2006/0082287 A1
(43) Pub. Date: Apr. 20, 2006

(54) Self-emission display device and method of manufacturing the same

(75) Inventors: Toshinao Yuki, Yamagata (JP); Masato Nakamura, Yamagata (JP)

Correspondence Address: ARENT FOX PLLC, 1050 CONNECTICUT AVENUE, N.W., SUITE 400, WASHINGTON, DC, 20036, US

(73) Assignee: TOHOKU PIONEER CORPORATION

(21) Appl. No.: 11/246,212

(22) Filed: Oct. 11, 2005

(30) Foreign Application Priority Data
Oct. 14, 2004 (JP) 2004-300322
Sep. 16, 2005 (JP) 2005-270646

(51) Int. Cl. H05B 33/14; H05B 33/18

(52) U.S. Cl. 313/503; 313/504; 313/506

(57) ABSTRACT

It is an object of the present invention to prevent a color tone deviation during a long-period use, so as to improve a displaying quality of a display device. Another object of the present invention is to ensure a universal use of each substrate and to prevent a complication of manufacturing process. The present invention is based on a self-emission display device in which self-emission elements of different luminescent colors are arranged in parallel or in a laminated manner, thereby enabling a color displaying by mixing a plurality of different colors. A luminescent layer of a self-emission element and a luminescent layer of another self-emission element are subjected to lowering adjustments of C1′→C1 and C2′→C2, so as to make uniform brightness deteriorations which are originally different due to different luminescent colors.

### BACKGROUND OF THE INVENTION

The present invention relates to a self-emission display device and a method of manufacturing the same.

The present application claims priority from Japanese Application No. 2004-300322, the disclosure of which is incorporated herein by reference.

A self-emission display device having (as its essential elements) self-emission elements such as organic EL elements can perform a flat panel displaying and this realizes a reduced power consumption and an increased displaying brightness as compared to a liquid crystal display for which back light is indispensable.

In performing a color (full color or multi-color) displaying using the aforementioned self-emission display device, it is usual to arrange self-emission elements of different luminescent colors in parallel or in a laminated manner in display units (pixels) so as to perform a color displaying by mixing a plurality of colors. Generally, in performing a full color displaying, it is possible to obtain a desired chromaticity by mixing three colors of R (red), G (green), and B (blue) at an appropriate brightness. In particular, it is possible to obtain a white color by causing the three colors to emit light at almost the same brightness. Further, not only the three colors, it is also possible to perform a multi-color displaying by mixing only two colors. Japanese Unexamined Patent Application Publication No. 2004-103532 discloses that it is possible to form the pixels of an organic EL panel by two-color organic EL elements, and that a mixture of such two colors makes it possible to exhibit colors within a circular area having a semi-diameter of 0.1, with the center thereof being a white area having CIExy chromaticity diagram or (x y)=(0.31, 0.316).

However, with regard to the aforementioned self-emission display device capable of color displaying, since the working life and the brightness deterioration extent of self-emission elements are different from one another due to different characteristics of different luminescent materials, a displaying performed during a long period can cause a color tone deviation, resulting in a problem that it is impossible to obtain a desired chromaticity. Particularly, in displaying a white color in a base displaying portion or the like of a screen, there is a problem that the white color displaying portion will be colored during a long-period use.

In order to cope with the foregoing problem, Japanese Unexamined Patent Application Publication Nos. 2001-290441 and 2003-195817 have provided the following disclosures. Namely, Japanese Unexamined Patent Application Publication No. 2001-290441 has disclosed that it is possible to ensure a white balance during a long-period use if a luminescent area of a luminescent zone of green color (in which the luminescent layer of EL elements forming displaying pixels of various colors arranged in matrix formation has the best luminescence efficiency) is made smallest as compared to a luminescent area of a luminescent zone of red or blue color. Further, Japanese Unexamined Patent Application Publication No. 2003-195817 has disclosed that a lighting time of a display device is measured and a control section is provided with a brightness adjusting unit for adjusting the brightness of luminescent materials of various colors in the display device, thereby preventing a color tone deviation during a long-period use.

However, with regard to the conventional technique disclosed in Japanese Unexamined Patent Application Publication No. 2001-290441, since different display devices of different product types require different panel designs, it is necessary each time to perform a patterning of apertures defining luminescent areas of luminescent zones, resulting in a complicated manufacturing process and making mass production difficult. Moreover, since the foregoing apertures are formed by virtue of an insulating film pattern (which is for use before a film formation step), it becomes difficult for a substrate (for use before the film formation step) to ensure its universal use. In addition, with regard to the conventional technique disclosed in Japanese Unexamined Patent Application Publication No. 2003-195817, it is necessary to include a specific circuit or the like to form a brightness adjusting unit, hence increasing the manufacturing cost.

### SUMMARY OF THE INVENTION

The present invention has been accomplished in order to cope with the foregoing problems, and it is an object of the present invention to provide an improved self-emission display device in which self-emission elements of different luminescent colors are arranged in parallel or in a laminated manner to perform a color displaying by mixing a plurality of different colors, so as to prevent a color tone deviation during a long-period use and thus improve a displaying quality of the display device, also to ensure a universal use of the substrate of the display device, and to avoid the complication of manufacturing process and an increased product cost.

In order to achieve the foregoing objects, a self-emission display device and a self-emission display device manufacturing method according to the present invention are characterized in the following aspects.

According to one aspect of the present invention, there is provided a self-emission display device in which self-emission elements of different luminescent colors are arranged in parallel or in a laminated manner, thereby enabling a color displaying by mixing a plurality of colors. In particular, self-emission elements of at least one of the plurality of luminescent colors have a luminescent functional layer whose electric current brightness efficiency degradation rate with respect to a driving time has been subjected to a lowering adjustment so as to make uniform different brightness deteriorations of different luminescent colors.

According to another aspect of the present invention, there is provided a method of manufacturing a self-emission display device in which self-emission elements of different luminescent colors are arranged in parallel or in a laminated manner, thereby enabling a color displaying by mixing a plurality of colors. Specifically, when forming a luminescent functional layer of self-emission elements of at least one of the plurality of luminescent colors, an electric current brightness efficiency degradation rate with respect to a driving time is subjected to a lowering adjustment so as to make uniform different brightness deteriorations of different luminescent colors.

### BRIEF DESCRIPTION OF THE DRAWINGS

These and other objects and advantages of the present invention will become clear from the following description with reference to the accompanying drawings, wherein:

FIG. 1 is an explanatory view showing an example of the basic structure of a self-emission display device formed according to an embodiment of the present invention;

FIG. 2 is a graph showing an embodiment of the present invention (indicating the brightness deterioration characteristics of self-emission elements with respect to each luminescent color); and

FIG. 3 is a flow chart showing a method of manufacturing a self-emission display device according to an embodiment of the present invention.

FIGS. 4A to 4C are graphs showing changes of electric current brightness efficiency with respect to driving time (life of each luminescent element), representing the examples of the present invention.

### DETAILED DESCRIPTION OF THE PREFERRED EMBODIMENTS

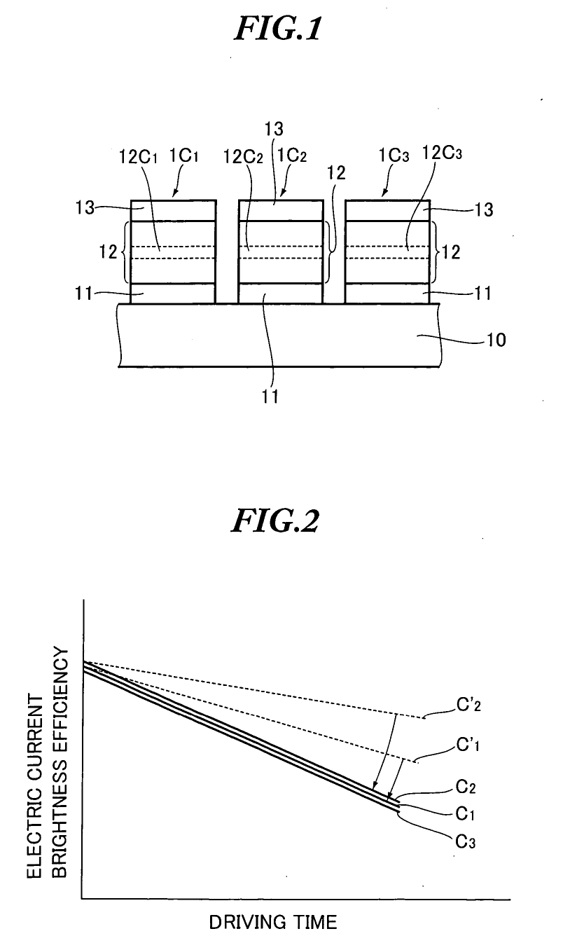

A preferred embodiment of the present invention will be described in the following with reference to the accompanying drawings. FIG. 1 is an explanatory view showing an example of the basic structure of a self-emission display device formed according to an embodiment of the present invention. As shown, the self-emission display device is formed by arranging in parallel on a substrate 10 a plurality of self-emission elements 1C₁, 1C₂, 1C₃ of different luminescent colors, so that it is possible to perform a color displaying by mixing a plurality of different colors. Here, although the illustrated example shows that the color displaying is performed by mixing color C₁ (for example, red (R)), color C₂ (for example, green (G)), and color C₃ (for example, blue (B)), the present invention should not be limited by this. In fact, it is also possible to perform a color displaying by mixing two or four different colors. Further, although the illustrated example shows that the respective self-emission elements 1C₁, 1C₂, and 1C₃ are arranged in parallel, this should not form any limitation to the present invention. Actually, it is also possible to arrange the self-emission elements in a laminated manner.

Here, each of the self-emission elements 1C₁ (1C₂, 1C₃) is formed by mounting a laminated structure on a substrate 10 and such laminated structure is formed by interposing a layered structure 12 containing a luminescent functional layer 12C₁ (12C₂, 12C₃) between a pair of electrodes (a lower electrode 11 and an upper electrode 13). In this way, when an electric voltage is applied between the lower electrode 11 and the upper electrode 13, holes will be injected and transported from one of the two electrodes into the self-emission element, while electrons will be injected and transported from the other of the two electrodes into the self-emission element, so that the holes and the electrons are recombined with each other in luminescent functional layer 12C₁ (12C₂, 12C₃), thereby effecting a light emission of one color. At this time, since an electric current flows between the lower electrode 11 and the upper electrode 13 due to the foregoing recombination, each self-emission element will exhibit a brightness corresponding to such an electric current. Here, the lower electrode 11 and the upper electrode 13 are so formed that their light-producing sides are composed of transparent conductive films, forming a bottom emission type in which light is emitted from the lower electrode 11 side or a top emission type in which light is emitted from the upper electrode 13 side. Further, when the self-emission elements 1C₁ (1C₂, 1C₃) are low molecular type organic EL elements, it is usual that a layered structure formed between a pair of electrodes is composed of organic layers including a hole transporting layer, a luminescent layer, an electron transporting layer or the like. Moreover, it is also possible for the self-emission elements 1C₁ (1C₂, 1C₃) to be formed by a single layer or a plurality of layers of bipolar materials, like high molecular type organic EL elements.

Usually, in the self-emission display device having the above-described structure, with regard to self-emission elements of different luminescent colors, there is a phenomenon which shows that an extent of brightness deterioration will be different from one luminescent color to another. In fact, when forming three colors (RGB) of self-emission elements using organic EL elements, the extents of brightness deteriorations with respect to a driving time will be in the order of B (blue), R(red) and G(green), with B (blue) being the highest and G(green) the lowest. Accordingly, if no specific adjustment is performed and a driving time accumulated becomes long, a tone color deviation will occur. For example, there will be a trouble that a white color which is to be displayed will be undesirably colored. However, in the present embodiment of the present invention, self-emission elements of at least one luminescent color among a plurality of colors have a luminescent functional layer whose electric current brightness efficiency with respect to a driving time has been lowly adjusted in a manner such that it is possible to make uniform the brightness deteriorations which are originally different from one another due to different luminescent colors. In this way, there would be no color tone deviation even if the device has been used for a long time.

The above description will be continued in further detail with reference to FIG. 2. In fact, FIG. 2 is a graph showing the brightness deterioration characteristics of self-emission elements of the respective luminescent colors. As shown, when the self-emission elements 1C₁, 1C₂, and 1C₃ are not adjusted, the deterioration rates of brightness efficiencies of these elements with respect to a driving time will be different from one another, as shown by C₁′ (broken line), C₂′ (broken line) and C₃ (solid line) in the graph. Therefore, the luminescent layer 12C₁ of the self-emission element 1C₁ and the luminescent layer 12C₂ Of the self-emission element 1C₂ are subjected to lowering adjustments of C1′→C1 and C2′→C2 so as to have all deterioration rates to be coincident with C₃ whose deterioration rate is the lowest, thereby making uniform the brightness deteriorations which are originally different due to different luminescent colors. Further, in the present embodiment of the present invention, since it is possible to perform the above-mentioned lowering adjustments in the film formation steps of forming the luminescent layers 12C₁ and 12C₂, it is possible to prevent any unfavorable influence on the universal use of a substrate prior to film formation, and to avoid an increased cost possibly caused due to some changes necessary to be made in control unit.

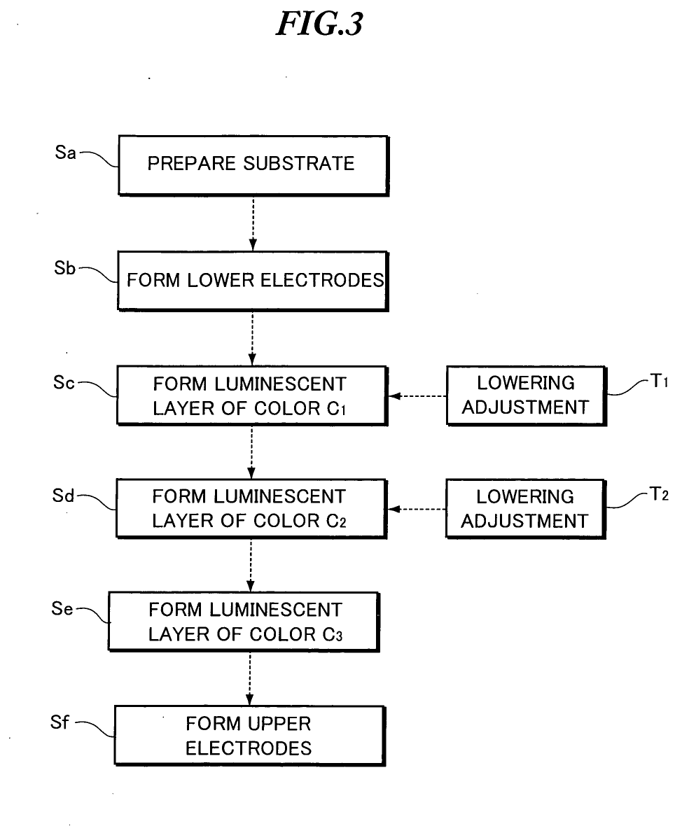

FIG. 3 is a flow chart showing an example of a method for manufacturing a self-emission display device according an embodiment of the present invention. As shown, in a process of forming self-emission elements for use in the self-emission device, a substrate 10 is prepared at first (substrate preparing step: Sa) and then lower electrodes 11 are formed on the substrate 10 directly or through other layers (lower electrode formation step: Sb). Then, a luminescent functional layer of color C₁ is formed on the lower electrodes 11 directly or through other layer(s) (step of forming luminescent functional layer of color C₁: Sc). Subsequently, a luminescent functional layer of color C₂ is also formed on the lower electrodes 11 directly or through other layer(s) (step of forming luminescent functional layer of color C₂: Sd). Moreover, a luminescent functional layer of color C₃ is also formed on the lower electrodes 11 directly or through other layer(s) (step of forming luminescent functional layer of color C₃: Se). On the other hand, the aforementioned lowering adjustment T₁ (which is an adjustment in accordance with a degradation rate of an electric current brightness efficiency with respect to a driving time) is performed when forming the luminescent functional layer of color C₁. Similarly, the aforementioned lowering adjustment T₂ is performed when forming the luminescent functional layer of color C₂. Of course, the order of the above steps of Sc, Sd, Se should not be limited by the embodiment described above. Then, the upper electrodes 13 are formed on these luminescent functional layers directly or through other layers. In particular, when self-emission elements are organic EL elements, the aforementioned film formation steps can be accomplished by performing a vapor deposition process suing a low molecular organic material, a coating or printing process by virtue of ink jet using a high molecular organic material, or a thermal transferring process in which a low molecular organic material is formed into a film in advance on a base film and then transferred by means of laser on to a substrate using a step of thermal transferring.

An example of a lowering adjustment mentioned above will be described in detail below.

[Lowering adjustment based on a concentration adjustment of a luminescent additive] When self-emission elements are organic EL elements, it is possible to perform the aforementioned lowering adjustment by adjusting the concentration of a guest material (a luminescent additive: dopant) added in the host material which includes the luminescent functional layers 12C₁ and 12C₂ Namely, if a dopant concentration is lowly adjusted with respect to the luminescent functional layers 12C₁ and 12C₂, it is possible to further lower a degradation rate of an electric current brightness efficiency with respect to a driving time. Further, a degradation of the electric current brightness efficiency can be reduced not only by lowering a dopant concentration, but also by adjusting the concentration of a dopant in a manner such that such concentration is higher than an optimum value of a dopant concentration of the luminescent functional layers of a host-guest system. By adjusting the concentration of a dopant with respect to the luminescent functional layers 12C₁ and 12C₂ whose colors suffer less brightness deterioration, it is possible to make uniform the different brightness deteriorations of different luminescent colors. Here, for use as such a dopant, it is allowed to use a luminescent central material to be added in a luminescent layer or an electron transporting layer, and it is also possible to use an electric charge transporting material.

[Lowering adjustment performed by adding an impurity which reduces luminescence function] When self-emission elements are organic EL elements, it is possible to perform the aforementioned lowering adjustment by adding an impurity in the luminescent functional layers 12C₁ and 12C₂ to reduce their luminescence functions. That is, by intentionally adding an impurity which causes the deterioration, it is possible to further reduce a degradation rate of an electric current brightness efficiency with respect to a driving time. Namely, it is possible to make uniform the different deteriorations of different luminescent colors by adding an impurity in the luminescent functional layers 12C₁ and 12C₂ whose colors suffer less brightness deterioration.

[Lowering adjustment performed by adjusting the thickness of luminescent functional layers and setting a layered structure thereof] When self-emission elements are organic EL elements, it is possible to perform the aforementioned lowering adjustment by not exactly setting the thickness of luminescent functional layers and the layered structure thereof at their optimum values. That is, with respect to self-emission elements having a high electric current brightness efficiency, a setting is performed to intentionally reduce a light take-out efficiency by making use of a reflection interference phenomenon, thereby further reducing the degradation rate of an electric current brightness efficiency with respect to a driving time. In this way, by performing such a setting with respect to the luminescent functional layers 12C₁ and 12C₂ whose colors suffer less brightness deterioration, it is possible to make uniform the different deteriorations of different luminescent colors.

The self-emission display device and its manufacturing method according to the above-described embodiment of the present invention are characterized as described above and formed on such a base that self-emission elements of different luminescent colors are arranged in parallel or in a laminated manner, thereby forming a self-emission display device capable of color displaying by mixing a plurality of different colors. In this way, it is possible to prevent a color tone deviation during a long-period use, so as to improve a displaying quality of the display device. Therefore, it is possible to ensure a universal use of each substrate, to prevent a complication of the manufacturing process, and to ensure a low production cost.

### EXAMPLES

Next, description will be given to explain some examples of the present invention using organic EL elements as self-emission elements. However, the present invention should not be limited by these examples.

The following examples are given as compared to a comparative example which is directed to organic EL elements having luminescent layers of R (red), G (green) and B (blue) colors, while the light emission brightness efficiency of each color is set at its maximum value. In detail, Example 1 shows that lowering adjustment has been carried out by adjusting the concentration of luminescent material (dopant) added in luminescent layer. Example 2 shows that lowering adjustment has been carried out by adjusting the thickness of luminescent layer in addition to concentration adjustment.

### Comparative Example

This comparative example relates to organic EL elements having a structure shown in FIG. 1, including a glass substrate 10 mounting a plurality of lower electrodes 11 consisting of ITO and serving as anodes. Formed on each lower electrode 11 is a laminated structure 12 consisting of a hole injection layer, a hole transporting layer, a luminescent layer, an electron transporting layer and an electron injection layer. Finally, an upper electrode 13 consisting of Al and serving as a cathode is formed on the top of each laminated structure. The organic EL elements are manufactured in the following process (Table 1 shows the materials and thicknesses of various layers forming each laminated structure, while the numerals within brackets represent thickness. Here, dopant concentrations shown below are represented by wt %. However, the indexes of dopant concentrations should not be limited by wt %. In fact, it is also possible to use vol %.

At first, vacuum vapor deposition is performed in each film formation chamber having a vacuum degree of 5.0×10⁻⁴ to form a plurality of laminated structures 12 on a glass substrate 10 mounting a plurality of anodes each consisting of ITO and having a thickness of 110 nm. In detail, copper phthalocyanine (CuPc) layer having a thickness of 30 nm is formed as a hole injection layer on the ITO, followed by forming an A-NPD layer having a thickness of 50 nm and serving as a hole transporting layer on the hole injection layer.

Subsequently, a vapor deposition mask for effecting a discriminative painting is used to define film formation areas for forming R-luminescent layer on the hole transporting layer, so as to perform a co-deposition of Alq₃ (host material) and DCJTB (dopant) using different vapor deposition sources, thereby forming an R-luminescent layer having a thickness of 40 nm. At this time, the concentration of DCJTB (dopant) was 6.0%. Afterwards, a vapor deposition mask for effecting a discriminative painting is used to define film formation areas for forming G-luminescent layer on the hole transporting layer, so as to perform a co-deposition of Alq₃ (host material) and Coumarin 6 (dopant) using different vapor deposition sources, thereby forming a G-luminescent layer having a thickness of 40 nm. At this time, the concentration of Coumarin (dopant) was 0.2%. Further, a vapor deposition mask for effecting a discriminative painting is used to define film formation areas for forming B-luminescent layer on the hole transporting layer, so as to perform a co-deposition of BH-140 (host material) and DB-052(dopant) using different vapor deposition sources, thereby forming a B-luminescent layer having a thickness of 30 nm. At this time, the concentration of BD-052 (dopant) was 5.0%. Here, BH-140 and BD-052 are product names of organic EL blue luminescent materials manufactured by Idemitsu Kosan Co., Ltd.

After that, an Alq₃ layer having a thickness of 30 nm is formed as an electron transporting layer, followed by forming thereon a lithium fluoride (LiF) layer having a thickness of 1 nm and serving as an electron injection layer. Finally, an aluminum (Al) layer having a thickness of 200 nm and serving as a cathode is formed on the electron injection layer.

TABLE 1
Materials and Thicknesses of Various Layers Forming Laminated
Structure (Numerals within brackets have units of nm)

| LAYER | | | |
|---|---|---|---|
| STRUCTURE | R (RED) | G (GREEN) | B (BLUE) |
| ELECTRON | LiF (1) | | |
| INJECTION | | | |
| LAYER | | | |
| ELECTRON | ALQ₃ (30) | | |
| TRANSPORTING | | | |
| LAYER | | | |
| LUMINESCENT | Alq₃ + | Alq₃ + | BH-140 + |
| LAYER | DCJTB (40) | Coumarin 6 (40) | BD-052 (30) |

| | |
|---|---|
| HOLE | α-NPD (50) |
| TRANSPORTING | |
| LAYER | |
| HOLE | CuPc (30) |
| INJECTION | |
| LAYER | |

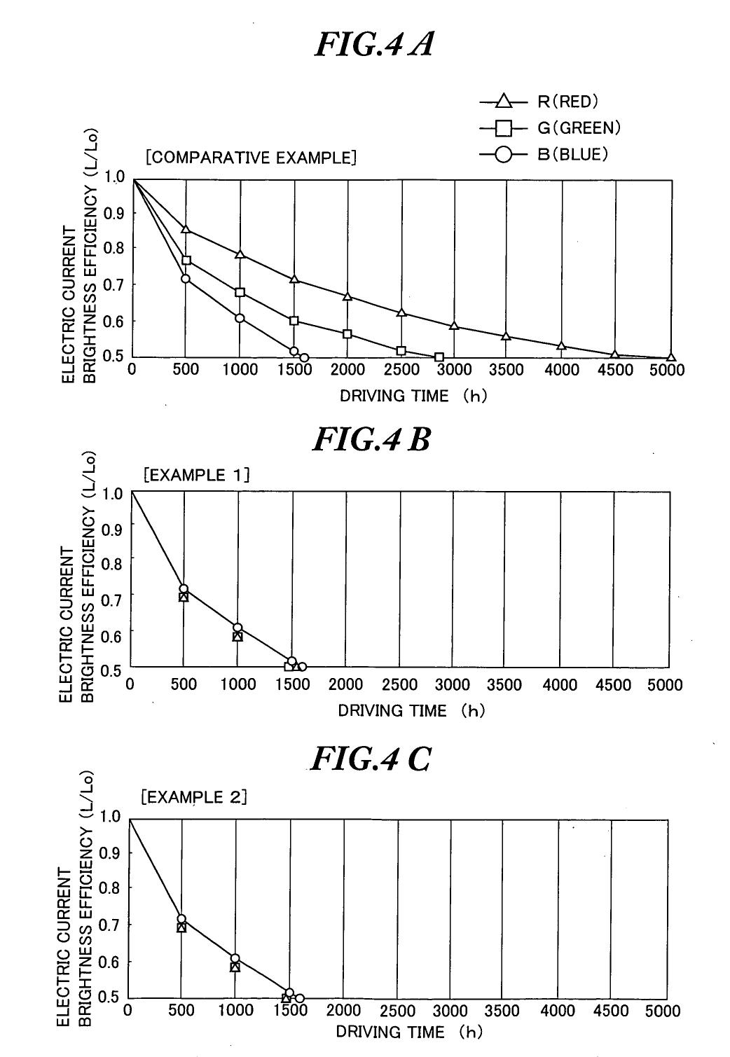

FIG. 4A is a graph showing changes of electric current brightness efficiency (life of each luminescent element) with respect to a driving time, under a condition in which respective organic EL elements (R, G, B) are driven by a constant electric current under a constant condition. Here, change of electric current brightness efficiency is represented as a rate of L/L₀ where L represents a luminescent brightness at the start of driving and L represents a luminescent brightness at certain time point after starting the driving.

In this comparative example, as clearly shown by the graph in FIG. 4A, different luminescent elements of different colors R, G, B have considerably different half value period lives (driving time at which L/L₀=0.5), with B being about 170 h, G being about 2790 h, R being about 4900 h, thereby establishing a relationship of B<G<R showing that different luminescent elements of different colors R, G, B have considerably different electric current brightness efficiencies with the passing of driving time. In this way, it is understood that even if a white balance has been adjusted at the start of driving, a color tone deviation will still occur due to a long-period driving.

### Example 1

Using the same materials and the same manufacturing process as the Comparative Example and setting the thicknesses of various layers of the laminated structures 12 at the same values as the Comparative Example, organic EL elements are formed by changing the dopant concentrations of R-luminescent layers and G-luminescent layers in a manner as shown in Table 2. In fact, Table 2 shows half value period lives when various luminescent elements of colors R, G, B have been driven by a constant electric current under a constant driving condition.

TABLE 2
Example 1

| | THICK- | CONCEN- | HALF VALUE | COMPARATIVE |
|---|---|---|---|---|
| | NESS | TRATION | PERIOD LIFE | EXAMPLE/ |
| COLOR | [nm] | [%] | [h] | EXAMPLE |
| R | 40 | 0.1 | 3350 | |
| | | 0.3 | 3350 | |
| | | 0.6 | 4900 | COMPARATIVE |
| | | | | EXAMPLE |
| | | 1.5 | 3350 | |
| | | 3.0 | 1550 | EXAMPLE |
| | | 6.0 | 650 | |
| G | 40 | 0.2 | 2790 | COMPARATIVE |
| | | | | EXAMPLE |
| | | 0.7 | 1490 | EXAMPLE |
| | | 1.5 | 1100 | |
| | | 3.0 | 490 | |
| B | 3.0 | 5.0 | 1610 | COMPARATIVE |
| | | | | EXAMPLE/ |
| | | | | EXAMPLE |

As clearly shown in Table 2, as compared to the Comparative Example, if the half value period life of R-luminescent layer is lower-adjusted from 4900 h to 1550 h by changing its dopant concentration from 0.6% to 3.0%, and if the half value period life of G-luminescent layer is lower-adjusted from 2790 h to 1490 h by changing its dopant concentration from 0.2% to 0.7%, it is possible for the half value period lives of luminescent elements of various colors R, G, B to be adjusted to a value around about 1500 h.

FIG. 4B is a graph showing changes of electric current brightness efficiency (life of each luminescent element) with respect to a driving time of each organic EL element (R: has a thickness of 40 nm and a dopant concentration of 3.0%; G: has a thickness of 40 nm and a dopant concentration of 0.7%; B: has a thickness of 30 nm and a dopant concentration of 5.0%) of each color (with each element lower-adjusted in its dopant concentration). In this way, if a white balance is adjusted at the start of driving, electric current brightness efficiencies of colors R, G, B will be almost the same as each other even if there has been a long-period driving. Therefore, it is possible to eliminate a color tone deviation usually caused due to a long-time driving.

### Example 2

The same materials and the same manufacturing process as the Comparative Example are used to change the dopant concentration and the thickness of each of R-luminescent layer and G-luminescent layer. Here, the dopant concentration of R-luminescent layer is adjusted to 0.3% and the dopant concentration of G-luminescent layer is adjusted to 0.7%, while the thickness of each of R-luminescent layer and G-luminescent layer is changed within a range of 10-40 nm. Table 3 shows half value period lives of various luminescent elements of colors R, G, B when they are driven by a constant electric current under a constant driving condition.

TABLE 3
Example 2

| | THICK- | CONCEN- | HALF VALUE | COMPARATIVE |
|---|---|---|---|---|
| | NESS | TRATION | PERIOD LIFE | EXAMPLE/ |
| COLOR | [nm] | [%] | [h] | EXAMPLE |
| R | 10 | 0.3 | 1480 | EXAMPLE |
| | 25 | | 2620 | |
| | 40 | | 3350 | |
| | 40 | 0.6 | 4900 | COMPARATIVE |
| | | | | EXAMPLE |
| G | 10 | 0.7 | 956 | |
| | 25 | | 1326 | |
| | 40 | | 1490 | EXAMPLE |
| | 40 | 0.2 | 2790 | COMPARATIVE |
| | | | | EXAMPLE |
| B | 30 | 5.0 | 1610 | COMPARATIVE |
| | | | | EXAMPLE/ |
| | | | | EXAMPLE |

As clearly shown in Table 3, with respect to the Comparative Example, if the half value period life of R-luminescent layer is lower-adjusted from 4900 h to 1480 h by changing its dopant concentration and its thickness, and if the half value period life of G-luminescent layer is lower-adjusted from 2790 h to 1490 h by changing its dopant concentration, it is possible for the half value period lives of luminescent elements of various colors R, G, B to be adjusted to a value around about 1500 h.

FIG. 4C is a graph showing changes of electric current brightness efficiency (life of each luminescent element) with respect to a driving time of each organic EL element (R: has a thickness of 10 nm and a dopant concentration of 0.3%; G: has a thickness of 40 nm and a dopant concentration of 0.7%; B: has a thickness of 30 nm and a dopant concentration of 5.0%) of each color (with each element lower-adjusted in its dopant concentration). In this way, if a white balance is adjusted at the start of driving, electric current brightness efficiencies of colors R, G, B will be almost the same as each other even if there has been a long-period driving. Therefore, it is possible to eliminate a color tone deviation usually caused due to a long-period driving.

While there has been described what are at present considered to be preferred embodiments of the present invention, it will be understood that various modifications may be made thereto, and it is intended that the appended claims cover all such modifications as fall within the true spirit and scope of the invention.

What is claimed is:

1. A self-emission display device in which self-emission elements of different luminescent colors are arranged in parallel or in a laminated manner, thereby enabling a color displaying by mixing a plurality of colors,
wherein self-emission elements of at least one of the plurality of luminescent colors have a luminescent functional layer whose electric current brightness efficiency degradation rate with respect to a driving time has been subjected to a lowering adjustment so as to make uniform different brightness deteriorations of different luminescent colors.

2. The self-emission display device according to claim 1, wherein the lowering adjustment is effected by adjusting the concentration of a luminescent additive added in the luminescent functional layer.

3. The self-emission display device according to claim 1, wherein the lowering adjustment is effected by adding an impurity for lowering a luminescence function in the luminescent functional layer.

4. The self-emission display device according to claim 1, wherein the lowering adjustment is effected by adjusting the thickness of the luminescent functional layer and setting a layered structure thereof.

5. The self-emission display device according to any one of claims 1 to 4, wherein each self-emission element is an organic EL element formed by interposing an organic layer containing the luminescent functional layer between a pair of electrodes.

6. A method of manufacturing a self-emission display device in which self-emission elements of different luminescent colors are arranged in parallel or in a laminated manner, thereby enabling a color displaying by mixing a plurality of colors,
wherein when forming a luminescent functional layer of self-emission elements of at least one of the plurality of luminescent colors, an electric current brightness efficiency degradation rate with respect to a driving time is subjected to a lowering adjustment so as to make uniform different brightness deteriorations of different luminescent colors.

7. The method according to claim 6, wherein the lowering adjustment is effected by adjusting the concentration of a luminescent additive added in the luminescent functional layer.

8. The method according to claim 6, wherein the lowering adjustment is effected by adding an impurity for lowering a luminescence function in the luminescent functional layer.

9. The method according to claim 6, wherein the lowering adjustment is effected by adjusting the thickness of the luminescent functional layer and setting a layered structure thereof.

10. The method according to any one of claims 6 to 9, wherein the formation of each self-emission element includes a step of forming a lower electrode on a substrate directly or through other layer(s), a step of forming the luminescent functional layer on the lower electrode directly or through other layer(s), and a step of forming an upper electrode on the luminescent functional layer directly or through other layer(s).
